(19) United States
(12) Patent Application Publication
(10) Pub. No.: US 2018/0154613 A1
(43) Pub. Date: Jun. 7, 2018

(54) FOAM ASSEMBLIES

(71) Applicant: SOLVAY SPECIALTY POLYMERS ITALY S.P.A., Bollate (IT)

(72) Inventors: Andrea RAPETTI, Milano (IT); Paula COJOCARU, Legnano (IT); Armin KLESING, Niederbreitbach (DE); Francesco Maria TRIULZI, Garbagnate Milanese (IT)

(73) Assignee: SOLVAY SPECIALTY POLYMERS ITALY S.p.A.

(21) Appl. No.: 15/575,338

(22) PCT Filed: May 17, 2016
(86) PCT No.: PCT/EP2016/061040

§ 371 Date: Nov. 17, 2017

(30) Foreign Application Priority Data
May 18, 2015 (EP) 15167958.6

(51) Int. Cl. B32B 15/082; B32B 27/32; C08J 9/228; C23C 18/16

(52) U.S. Cl. CPC B32B 15/082; C23C 18/16; C08J 9/228; B32B 27/322

(57) ABSTRACT

The present invention pertains to a foam assembly, to a process for its manufacture and to uses of said foam assembly in various applications.

This application claims priority to European application No. 15167958.6 filed on May 18, 2015, the whole content of this application being incorporated herein by reference for all purposes.

### TECHNICAL FIELD

The present invention pertains to a foam assembly, to a process for its manufacture and to uses of said foam assembly in various applications.

### BACKGROUND ART

Insulation blankets are widely used in various applications including aerospace applications to provide a flame spread barrier so as to protect passengers of an aircraft in the event of a fire such as ground fuel fire or a post-crash fire.

The use of materials with improved fire resistance was mandated by the

Federal Aviation Administration (FAA) in 1987 with requirements for the burning rate and flame spread of seat cushions and in 1990 with the establishment of regulations limiting the heat release rate of large area cabin interior components. These regulations provide for an additional 2-4 minutes of cabin escape time in the event of an aircraft accident involving a post-crash fuel fire outside the cabin.

To address these concerns, fire resistant materials are typically added to manufactured materials such as plastics and textiles that inhibit, suppress, or delay the production of flames, smokes and toxic fumes to prevent the spread of fire. They may be mixed with the base material (additive flame retardants) or chemically bonded to it (reactive flame retardants).

There thus remains a need in the art for assemblies providing for an improved flame spread resistance to be suitably used in various applications.

### SUMMARY OF INVENTION

It has been now found that the multilayer assembly of the invention is advantageously endowed with outstanding flame spread resistance so that emissions of toxic gases during a fire are successfully drastically reduced.

In a first instance, the present invention pertains to a multilayer assembly comprising, preferably consisting of:
a core consisting of a composition [composition (C)] comprising, preferably consisting of, at least one polymer foam [foam (P)] and,
adhered to said core, a metal shell at least partially coating said core, said metal shell comprising, preferably consisting of, at least one layer [layer (L1)], said layer (L1) consisting of a composition [composition (C1)] comprising at least one metal compound [compound (M1)], and, optionally, at least one layer [layer (L2)], said layer (L2) consisting of a composition [composition (C2)] comprising at least one metal compound [compound (M2)].

The Applicant has found that, despite a relatively low thickness of the metal shell at least partially coating the core, the multilayer assembly of the invention is advantageously a self-standing multilayer assembly.

Also, the Applicant has found that the multilayer assembly of the invention exhibits outstanding interlayer adhesion properties between the core and the metal shell so that no adhesive layer is needed in order to provide for adhesion of the polymer foam of the core to the metal shell.

The multilayer assembly of the invention typically further comprises an outer shell, said outer shell surrounding the metal shell.

According to an embodiment of the invention, the outer shell is adhered to the metal shell, optionally through an adhesive layer.

The outer shell of the multilayer assembly of the invention, if any, typically consists of a material selected from the group consisting of metal compounds, polymers, polymer fibers and polymer-based composites such as fiber-reinforced polymers and mixtures thereof.

Non-limiting examples of suitable polymer fibers include, for instance, fibers consisting of a polymer selected from the group consisting of polyamides, polyesters, polyimides, poly(aryl ether ketone) polymers [polymers (PAEK)], poly(phenylene sulfone) polymers [polymers (PPSU)], poly(ether sulfone) polymer [polymers (PESU)] and fluoropolymers [polymers (F)].

The outer shell of the multilayer assembly of the invention, if any, may be a non-woven fabric consisting of at least one polymer fiber as defined above.

Non-limiting examples of suitable fiber-reinforced polymers include, for instance, fiber-reinforced polymers wherein said fiber is selected from the group consisting of carbon, aramide and glass fibers and said polymer is selected from the group consisting of polyamides, polyesters, polyimides, poly(aryl ether ketone) polymers [polymers (PAEK)], poly(phenylene sulfone) polymers [polymers (PPSU)], poly(ether sulfone) polymer [polymers (PESU)] and fluoropolymers [polymers (F)].

The multilayer assembly of the invention may have any geometrical shape.

For the purpose of the present invention, the term “polymer foam [foam (P)]” is intended to denote a solid polymer matrix having incorporated therein gas pockets.

The foam (P) typically has a density comprised between 5 and 300 Kg/m³, preferably between 20 and 200 Kg/m³.

The density of the foam (P) is typically measured by any suitable techniques such as, for instance, according to ISO 845 standard method.

The foam (P) may be either an open-cell polymer foam [foam (PO)] or a closed-cell polymer foam [foam (PC)].

For the purpose of the present invention, the term “open-cell polymer foam [foam (PO)]” is intended to denote a polymer foam wherein the gas pockets connect with each other.

For the purpose of the present invention, the term “closed-cell polymer foam [foam (PC)]” is intended to denote a polymer foam wherein the gas forms discrete pockets, each completely surrounded by the solid polymer matrix.

The foam (P) is advantageously obtainable by any suitable processes including, but not limited to, batch foaming, foaming extrusion and moulding of polymer foam beads [foam beads (P)].

Thus, according to an embodiment of the invention, the foam (P) comprises, preferably consists of, at least one polymer foam bead [foam bead (P)].

For the purpose of the present invention, the term “polymer foam bead [foam bead (P)]” is intended to denote a solid polymer matrix consisting of one or more polymer foam beads having incorporated therein gas pockets.

The foam bead (P) is advantageously an expanded foam bead (P).

The foam bead (P) is typically obtainable by a process comprising:
dispersing polymer beads in a dispersing medium in a closed vessel,
impregnating the polymer beads with a blowing agent thereby providing expandable polymer beads, and
discharging the expandable polymer beads together with said dispersing medium from said closed vessel to an area wherein the pressure is lower than the pressure of the closed vessel.

Processes suitable for manufacturing a foam (P) by moulding of foam beads (P) are disclosed, for instance, in WO 2010/103771 (JSP CORPORATION) Sep. 16, 2010 and in US 2014/0171524 (JSP CORPORATION) Jun. 19, 2014.

In a second instance, the present invention pertains to a process for the manufacture of the multilayer assembly of the invention.

The Applicant has surprisingly found that by the process of the invention it is advantageously possible coating, in the presence of liquid media, a polymer foam with a metal shell, while avoiding use of vacuum deposition techniques.

According to a first embodiment of the invention, the process for the manufacture of the multilayer assembly of the invention comprises:

(i) providing a core consisting of a composition [composition (C)] comprising, preferably consisting of, at least one polymer foam [foam (P)],

(ii) treating at least a portion of the surface of the core provided in step (i) by a radio-frequency glow discharge process using an etching gas medium,

(iii) providing a metal shell, said metal shell being obtainable by:

(iii-a) coating by electroless deposition at least a portion of the core provided in step (ii) using a liquid composition [composition (L1)] comprising at least one metal salt [salt (M1)] thereby providing at least one layer [layer (L1)], said layer (L1) consisting of a composition [composition (C1)] comprising at least one metal compound [compound (M1)], and

(iii-b) optionally, coating by electrodeposition at least a portion of the layer (L1) provided in step (iii-a) using a liquid composition [composition (C2)] comprising at least one metal salt [salt (M2)] thereby providing at least one layer [layer (L2)] consisting of a composition [composition (C2)] comprising at least one metal compound [compound (M2)], and

(iv) optionally, applying an outer shell onto the metal shell provided in either step (iii-a) or step (iii-b), if any.

According to a second embodiment of the invention, the process for the manufacture of the multilayer assembly of the invention comprises:

(i′) providing a core consisting of a composition [composition (C′)] comprising, preferably consisting of, at least one polymer foam bead [foam bead (P)],

(ii′) treating at least a portion of the surface of the core provided in step (i′) by a radio-frequency glow discharge process using an etching gas medium,

(iii′) providing a metal shell, said metal shell being obtainable by:

(iii-a′) coating by electroless deposition at least a portion of the core provided in step (ii′) using a liquid composition [composition (L1)] comprising at least one metal salt [salt (M1)] thereby providing at least one layer [layer (L1)], said layer (L1) consisting of a composition [composition (C1)] comprising at least one metal compound [compound (M1)], and

(iii-b′) optionally, coating by electrodeposition at least a portion of the layer (L1) provided in step (iii-a′) using a liquid composition [composition (C2)] comprising at least one metal salt [salt (M2)] thereby providing at least one layer [layer (L2)] consisting of a composition [composition (C2)] comprising at least one metal compound [compound (M2)],

(iv′) moulding the foam beads (P) provided in either step (iii-a′) or step (iii-b′) thereby providing a multilayer assembly, and

(v′) optionally, applying an outer shell onto the multilayer assembly provided in step (iv′).

The multilayer assembly obtainable by the process of this second embodiment of the invention is a multilayer assembly as defined above, wherein the foam (P) comprises, preferably consists of, at least one foam bead (P).

The foam bead (P) of the core of the multilayer assembly obtainable by the process of this second embodiment of the invention advantageously has, adhered to said foam bead (P), a metal shell at least partially coating said foam bead (P), said metal shell comprising, preferably consisting of, at least one layer [layer (L1)], said layer (L1) consisting of a composition [composition (C1)] comprising at least one metal compound [compound (M1)], and, optionally, at least one layer [layer (L2)], said layer (L2) consisting of a composition [composition (C2)] comprising at least one metal compound [compound (M2)].

The multilayer assembly of the invention is suitable for use in various applications including, but not limited to, aerospace, rail, automotive, packaging and industrial applications.

In a third instance, the present invention pertains to use of the multilayer assembly of the invention in aerospace, rail, automotive, packaging and industrial applications.

The multilayer assembly of the invention is particularly suitable for use in interior parts of a vehicle, in particular floors, sidewalls, ceilings and stowage bins.

In particular, when the multilayer assembly of the invention is used in aerospace applications, due to its relatively low weight per total volume, it advantageously provides for both improved fuel efficiency and payload capacity of an aircraft comprising the same.

The foam (P) typically comprises, preferably consists of, at least one thermoplastic polymer [polymer (T)].

For the purpose of the present invention, the term “thermoplastic” is intended to denote polymers existing, at room temperature, below their glass transition temperature, if they are amorphous, or below their melting point, if they are semi-crystalline. These polymers have the property of becoming soft when they are heated and of becoming rigid again when they are cooled, without there being an appreciable chemical change. Such a definition may be found, for example, in the encyclopaedia called Polymer Science Dictionary. Edited by MARK S. M. ALGER. London: Elsevier Applied Science, 1989. p. 476.

The foam (P) typically comprises, preferably consists of, at least one polymer selected from the group consisting of fluoropolymers [polymers (F)], poly(aryl ether ketone) polymers [polymers (PAEK)], poly(arylene sulfide) polymers [polymers (PAS)], poly(phenylene sulfone) polymers [polymers (PPSU)], poly(sulfone) polymers [polymers (PSU)], poly(ether sulfone) polymer [polymers (PESU)], poly(arylene) polymers [polymers (PA)], aromatic and aliphatic polyamides, polyimides, polyetherimides, polyesters such as polyethylene terephthalate, polymelamines, cellulosic fibers such as balsa, phenolic resins and epoxy resins, polyolefins such as polyethylene and polypropylene, vinyl chloride-based polymers, polycarbonates and polyurethanes.

For the purpose of the present invention, the term “fluoropolymer [polymer (F)]” is intended to denote a polymer comprising, preferably consisting of, recurring units derived from at least one fluorinated monomer [monomer (F)] and, optionally, at least one hydrogenated monomer [monomer (H)].

By the term “fluorinated monomer [monomer (F)]” it is hereby intended to denote an ethylenically unsaturated monomer comprising at least one fluorine atom and, optionally, at least one hydrogen atom.

By the term “hydrogenated monomer [monomer (H)]” it is hereby intended to denote an ethylenically unsaturated monomer comprising at least one hydrogen atom and free from fluorine atoms.

The term “at least one fluorinated monomer” is understood to mean that the polymer (F) may comprise recurring units derived from one or more than one fluorinated monomers. In the rest of the text, the expression “fluorinated monomers” is understood, for the purposes of the present invention, both in the plural and the singular, that is to say that they denote both one or more than one fluorinated monomers as defined above.

The term “at least one hydrogenated monomer” is understood to mean that the polymer (F) may comprise recurring units derived from one or more than one hydrogenated monomers. In the rest of the text, the expression “hydrogenated monomers” is understood, for the purposes of the present invention, both in the plural and the singular, that is to say that they denote both one or more than one hydrogenated monomers as defined above.

The polymer (F) is typically obtainable by polymerization of at least one fluorinated monomer [monomer (F)] and, optionally, at least one hydrogenated monomer [monomer (H)].

Non-limiting examples of suitable monomers (F) include, notably, the followings:
C₂-C₈ perfluoroolefins such as tetrafluoroethylene and hexafluoropropylene,
C₂-C₈ hydrogenated fluoroolefins such as vinylidene fluoride, vinyl fluoride, 1,2-difluoroethylene and trifluoroethylene,
perfluoroalkylethylenes of formula CH₂═CH—R_{f0} wherein R_{f0} is a C₁-C₆ perfluoroalkyl,
chloro- and/or bromo- and/or iodo-C₂-C₆ fluoroolefins such as chlorotrifluoroethylene,
(per)fluoroalkylvinylethers of formula CF₂═CFOR_{f1} wherein R_{f1} is a C₁-C₆ fluoro- or perfluoroalkyl group, e.g. CF₃, C₂F₅, C₃F₇,
CF₂═CFOX₀ (per)fluoro-oxyalkylvinylethers wherein X₀ is a C₁-C₁₂ alkyl group, a C₁-C₁₂ oxyalkyl group or a C₁-C₁₂ (per)fluorooxyalkyl group having one or more ether groups, such as perfluoro-2-propoxy-propyl group,
(per)fluoroalkylvinylethers of formula CF₂═CFOCF₂OR_{f2} wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups such as —C₂F₅ —O—CF₃,
functional (per)fluoro-oxyalkylvinylethers of formula CF₂═CFOY₀ wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form, and
fluorodioxoles, preferably perfluorodioxoles.

The polymer (F) is preferably selected from the group consisting of:
polymers (F-1) comprising recurring units derived from vinylidene fluoride (VDF) and, optionally, at least one monomer (F) different from VDF,
polymers (F-2) comprising recurring units derived from at least one monomer (F) selected from tetrafluoroethylene (TFE) and chlorotrifluoroethylene (CTFE), at least one monomer (H) selected from ethylene (E), propylene and isobutylene and, optionally, at least one monomer (F) different from said TFE and/or ECTFE, typically in an amount of from 0.01% to 30% by moles, based on the total amount of TFE and/or CTFE and said monomer (H), and
polymers (F-3) comprising recurring units derived from tetrafluoroethylene (TFE) and at least one monomer (F) selected from the group consisting of perfluoroalkylvinylethers of formula CF₂═CFOR_{f1′}, wherein R_{f1′} is a C₁-C₆ perfluoroalkyl group, and C₃-C₈ perfluoroolefins such as hexafluoropropylene (HFP).

The polymer (F-1) preferably comprises:

(a) at least 60% by moles, preferably at least 70% by moles, more preferably at least 80% by moles of vinylidene fluoride (VDF), and

(b) optionally, from 0.1% to 40% by moles, preferably from 0.1% to 30% by moles, more preferably from 0.1% to 20% by moles, based on the total amount of monomers (a) and (b), of at least one monomer (F) selected from the group consisting of vinyl fluoride (VF₁), chlorotrifluoroethylene (CTFE), hexafluoropropylene (HFP), tetrafluoroethylene (TFE), trifluoroethylene (TrFE) and perfluoromethylvinylether (PMVE).

The polymer (F-1) may further comprise from 0.1% to 5% by moles, preferably from 0.1% to 3% by moles, more preferably from 0.1% to 1% by moles, based on the total amount of monomers (a) and (b), of at least one monomer (H).

The polymer (F-1) is preferably selected from the group consisting of homopolymers of VDF, VDF/TFE copolymers, VDF/TFE/HFP copolymers, VDF/TFE/CTFE copolymers, VDF/TFE/TrFE copolymers, VDF/CTFE copolymers, VDF/HFP copolymers, VDF/TFE/HFP/CTFE copolymers, VDF/TFE/perfluorobutenoic acid copolymers, VDF/TFE/maleic acid copolymers and the like.

The polymer (F-1) is more preferably selected from the group consisting of homopolymers of VDF and copolymers of VDF with 0.1% to 10% by moles of a fluorinated comonomer selected from the group consisting of chlorotrifluoroethylene (CTFE), hexafluoropropene (HFP), tetrafluoroethylene (TFE), trifluoroethylene (TrFE) and mixtures thereof.

The polymer (F-1) typically has a melting point of at least 120° C., preferably of at least 135° C., more preferably of at least 150° C.

The polymer (F-1) typically has a melting point of at most 190° C., preferably of at most 185° C., more preferably of at most 180° C.

The melting point was measured by Differential Scanning Calorimetry (DSC), at a heating rate of 10° C./min, according to ASTM D 3418.

The polymer (F-1) typically has a heat of fusion of at least 10 J/g, preferably of at least 20 J/g.

The polymer (F-1) typically has a heat of fusion of at most 70 J/g, preferably of at most 40 J/g, more preferably of at most 30 J/g.

The heat of fusion was measured by Differential Scanning Calorimetry (DSC), at a heating rate of 10° C./min, according to ASTM D 3418.

Polymers (F-2) wherein the monomer (FX) is chlorotrifluoroethylene (CTFE) will be identified herein below as ECTFE copolymers; polymers (F-2) wherein the monomer (FX) is tetrafluoroethylene (TFE) will be identified herein below as ETFE copolymers.

The polymer (F-2) preferably comprises:

(a′) from 10% to 90% by moles, preferably from 30% to 70% by moles of at least one monomer (FX) selected from the group consisting of chlorotrifluoroethylene (CTFE) and tetrafluoroethylene (TFE), and

(b′) from 10% to 90% by moles, preferably from 30% to 70% by moles, based on the total amount of monomers (a′) and (b′), of ethylene (E).

The polymer (F-2) more preferably comprises, even more preferably consists of:

(a′) from 50% to 70% by moles, preferably from 53% to 65% by moles of at least one monomer (FX) selected from the group consisting of chlorotrifluoroethylene (CTFE) and tetrafluoroethylene (TFE), and

(b′) from 30% to 50% by moles, preferably from 35% to 47% by moles, based on the total amount of monomers (a′) and (b′), of ethylene (E).

The polymer (F-2) may further comprise from 0.1% to 30% by moles, preferably from 0.1% to 15% by moles, more preferably from 0.1% to 10% by moles, based on the total amount of monomers (a′) and (b′), of at least one other monomer selected from the group consisting of monomers (F) and monomers (H).

Nevertheless, ECTFE polymers free from other monomers are preferred.

End chains, defects or minor amounts of monomer impurities leading to recurring units different from those above mentioned can be still comprised in the preferred ECTFE, without affecting properties of the material.

The polymer (F-2) typically has a melting point of at least 120° C., preferably of at least 130° C., more preferably of at least 140° C., even more preferably of at least 150° C.

The polymer (F-2) typically has a melting point of at most 210° C., preferably of at most 200° C., more preferably of at most 195° C., even more preferably of at most 190° C.

The melting point was measured by Differential Scanning Calorimetry (DSC), at a heating rate of 10° C./min, according to ASTM D 3418.

The polymer (F-2) typically has a heat of fusion of at least 1 J/g, preferably of at least 2 J/g, more preferably of at least 5 J/g.

The polymer (F-2) typically has a heat of fusion of at most 35 J/g, preferably of at most 30 J/g, more preferably of at most 25 J/g.

The heat of fusion was measured by Differential Scanning Calorimetry (DSC), at a heating rate of 10° C./min, according to ASTM D 3418.

The polymer (F-2) typically has a melt flow rate of from 0.01 to 75 g/10 min, preferably of from 0.1 to 50 g/10 min, more preferably of from 0.5 to 30 g/10 min, as measured according to ASTM 3275-81 standard procedure at 230° C. under a load of 2.16 Kg.

The polymer (F-3) is preferably a polymer (F-3A) comprising recurring units derived from tetrafluoroethylene (TFE) and at least one perfluoroalkylvinylether selected from the group consisting of perfluoromethylvinylether of formula CF₂═CFOCF₃, perfluoroethylvinylether of formula CF₂═CFOC₂F₅ and perfluoropropylvinylether of formula CF₂═CFOC₃F₇.

The polymer (F-3) typically has a melting point comprised between 200° C. and 320° C.

The melting point was measured by Differential Scanning Calorimetry (DSC), at a heating rate of 10° C./min, according to ASTM D 3418.

Non-limiting examples of suitable polymers (F-3) include, notably, those commercially available under the trademark name HYFLON® PFA P and M series and HYFLON® MFA from Solvay Specialty Polymers Italy S.p.A.

For the purpose of the invention, the term “poly(aryl ether ketone) polymer [polymer (PAEK)]” is intended to denote any polymer comprising recurring units wherein more than 50% by moles of said recurring units are recurring units (R_{PAEK}) comprising a Ar—C(O)—Ar′ group, wherein Ar and Ar′, equal to or different from each other, are aromatic moieties comprising at least one aromatic mono- or poly-nuclear cycle. The recurring units (R_{PAEK}) are generally selected from the group consisting of those of formulae (J-A) to (J-O) here below:

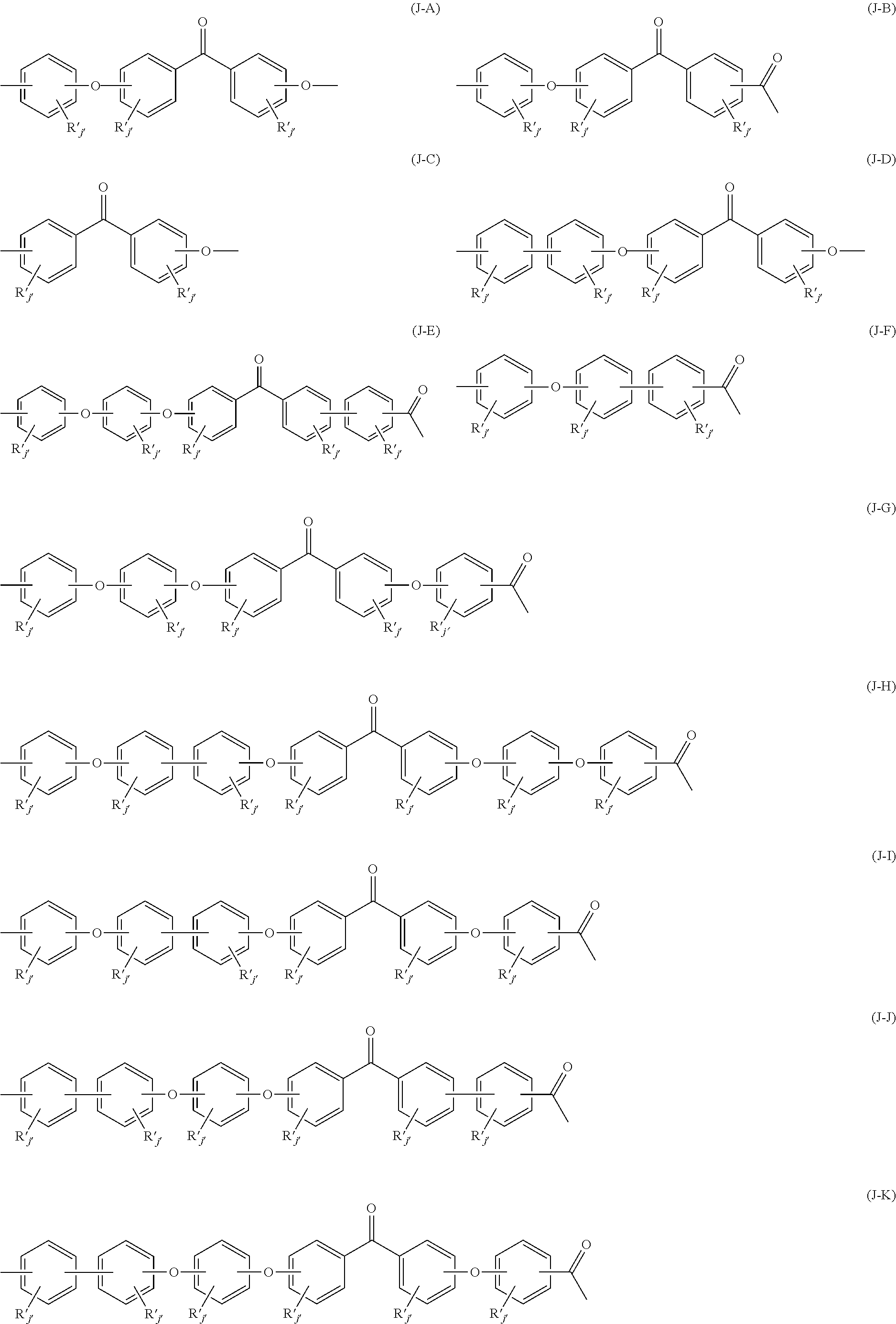

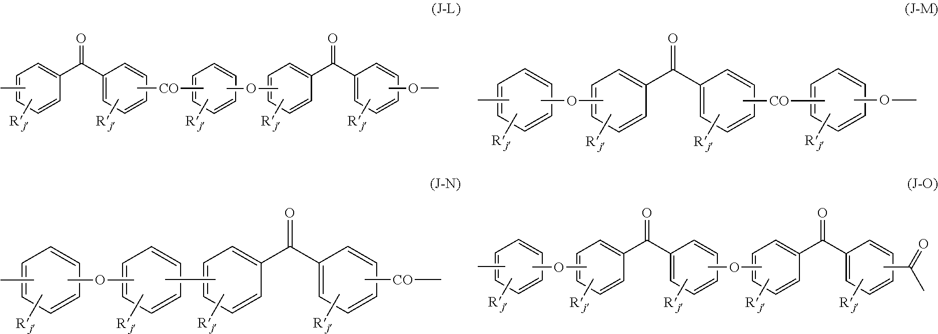

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or an integer from 1 to 4.

In recurring units (R_{PAEK}), the respective phenylene moieties may independently have 1,2-, 1,4- or 1,3 -linkages to the other moieties different from R′ in the recurring units. Preferably, said phenylene moieties have 1,3- or 1,4-linkages, more preferably they have 1,4-linkages.

Still, in recurring units (R_{PAEK}), j′ can be at each occurrence zero, that is to say that the phenylene moieties have no other substituents than those enabling linkage in the main chain of the polymer (PAEK).

Preferred recurring units (R_{PAEK}) are thus selected from the group consisting of those of formulae (J′-A) to (J′-O) here below:

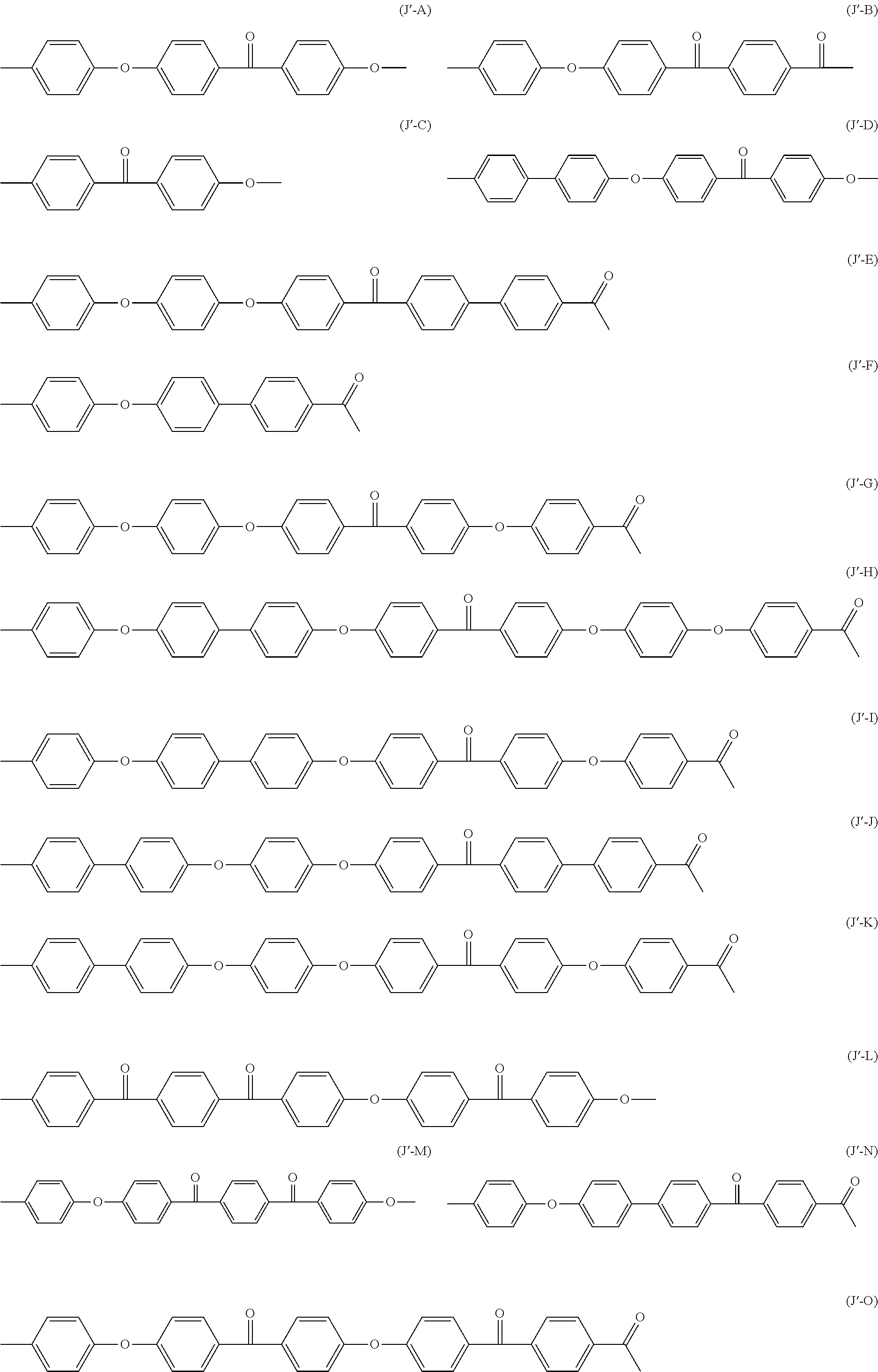

In the polymer (PAEK), as defined above, preferably more than 60% by moles, more preferably more than 80% by moles, even more preferably more than 90% by moles of the recurring units are recurring units (R_{PAEK}) as defined above.

Still, it is generally preferred that substantially all recurring units of the polymer (PAEK) are recurring units (R_{PAEK}) as defined above; chain defects or minor amounts of other recurring units might be present, being understood that these latter do not substantially modify the properties of recurring units (R_{PAEK}).

The polymer (PAEK) may be notably a homopolymer or a copolymer such as a random, alternate or block copolymer. When the polymer (PAEK) is a copolymer, it may notably contain (i) recurring units (R_{PAEK}) of at least two different formulae chosen from formulae (J-A) to (J-O), or (ii) recurring units (R_{PAEK}) of one or more formulae (J-A) to (J-O) and recurring units (R*_{PAEK}) different from recurring units (R_{PAEK}).

As will be detailed later on, the polymer (PAEK) may be a poly(ether ether ketone) polymer [polymer (PEEK)]. For the purpose of the present invention, the term “poly(ether ether ketone) polymer [polymer (PEEK)]” is intended to denote any polymer comprising recurring units wherein more than 50% by moles of said recurring units are recurring units (R_{PAEK}) of formula J′-A.

Preferably more than 75% by moles, more preferably more than 85% by moles, even more preferably more than 95% by moles, still more preferably more than 99% by moles of the recurring units of the polymer (PEEK) are recurring units (R_{PAEK}) of formula J′-A. Most preferably, all the recurring units of the polymer (PEEK) are recurring units (R_{PAEK}) of formula J′-A.

Non-limiting examples of polymers (PAEK) suitable for the invention include those commercially available under the trademark name KETASPIRE® PEEK from Solvay Specialty Polymers USA L.L.C.

For the purpose of the present invention, the term “poly(arylene sulfide) polymer [polymer (PAS)]” is intended to denote any polymer comprising recurring units wherein more than 50% by moles of said recurring units are recurring units (R_{PAS}) of formula:

—(Ar—S)—

wherein Ar denotes an aromatic moiety comprising at least one aromatic mono- or poly-nuclear cycle, such as a phenylene or a naphthylene group, which is linked by each of its two ends to two sulfur atoms forming sulfide groups via a direct C—S linkage.

In recurring units (R_{PAS}), the aromatic moiety Ar may be substituted by one or more substituent groups, including but not limited to halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

The polymer (PAS) preferably comprises more than 70% by moles, more preferably more than 80% by moles, still more preferably more than 90% by moles of recurring units (R_{PAS}).

Most preferably, the polymer (PAS) contains no recurring units other than recurring units (R_{PAS}).

In recurring units (R_{PAS}), the aromatic moiety Ar is preferably selected from the group consisting of those of formulae (X-A) to (X-K) here below:

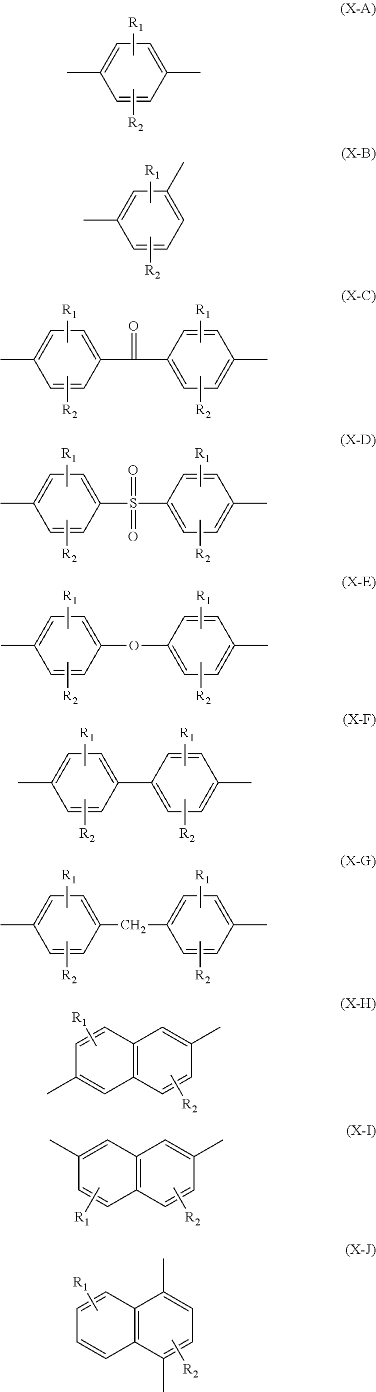

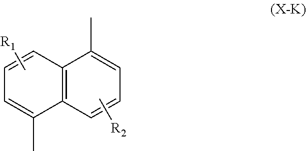

wherein R₁ and R₂, equal to or different from each other, are selected from the group consisting of hydrogen atoms, halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

The polymer (PAS) may be a homopolymer or a copolymer such as a random copolymer or a block copolymer.

The polymer (PAS) typically comprises one or more branched or cross-linked recurring units selected from the group consisting of those of formulae (X-L) to (X-N) here below:

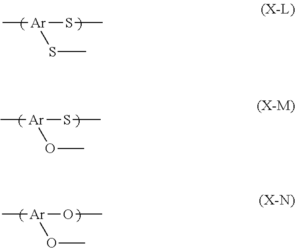

The polymer (PAS) is preferably a poly(phenylene sulfide) polymer [polymer (PPS)]. For the purpose of the present invention, the term “poly(phenylene sulfide) polymer [polymer (PPS)]” is intended to denote any polymer comprising recurring units wherein more than 50% by moles of said recurring units are p-phenylene sulfide recurring units (R_{PPS}) of formula:

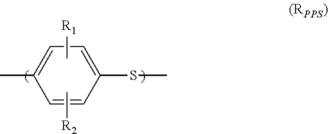

wherein the p-phenylene group is linked by each of its two ends to two sulfur atoms forming sulfide groups via a direct C—S linkage, wherein R₁ and R₂, equal to or different from each other, are selected from the group consisting of hydrogen atoms, halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

Non-limiting examples of polymers (PPS) suitable for the invention include those commercially available under the trademark names PRIMEF® from Solvay Specialty Polymers USA L.L.C., RYTON® from Chevron Phillips Chemical Company L.L.C., FORTRON® from Fortron Industries and SUPEC® from GE Plastics.

For the purpose of the invention, the term “poly(phenylene sulfone) polymer [polymer (PPSU)]” is intended to denote any polymer comprising recurring units wherein more than 50% by moles of the recurring units of said polymer (PPSU) are recurring units (R_{PPSU}) of formula (K-A):

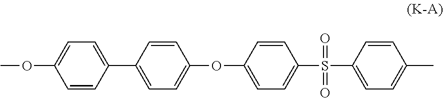

In a preferred embodiment of the present invention, more than 75% by moles, preferably more than 90% by moles, more preferably more than 99% by moles, even more preferably substantially all the recurring units of the polymer (PPSU) are recurring units (R_{PPSU}) of formula (K-A), chain defects or minor amounts of other recurring units might be present, being understood that these latter do not substantially modify the properties of the polymer (PPSU).

The polymer (PPSU) polymer may be notably a homopolymer or a copolymer such as a random copolymer or a block copolymer. When the (PPSU) polymer is a copolymer, its recurring units are advantageously a mix of recurring units (R_{PPSU}) of formula (K-A) and of recurring units (R_{PPSU*}), different from recurring units (R_{PPSU}), such as recurring units of formula (K-B), (K-C) or (K-D):

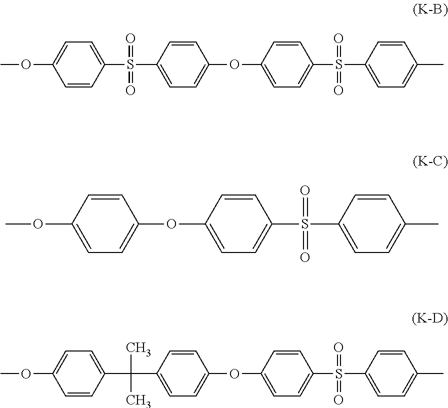

and mixtures thereof.

The polymer (PPSU) can also be a blend of a homopolymer and a copolymer as defined above.

Non-limiting examples of polymers (PPSU) suitable for the invention include those commercially available under the trademark names RADEL® R PPSU from Solvay Specialty Polymers USA L.L.C.

For the purpose of the present invention, the term “poly(sulfone) polymer [polymer (PSU)]” is intended to denote an aromatic sulfone polymer wherein at least 50% by moles, preferably at least 60% by moles, more preferably at least 70% by moles, even more preferably at least 80% by moles and most preferably at least 90% by moles of the recurring units of said polymer (PSU) are recurring units of formula:

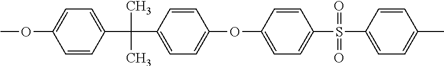

Non-limiting examples of polymers (PSU) suitable for the invention include those commercially available under the trademark name UDEL® PSU from Solvay Specialty Polymers USA L.L.C.

For the purpose of the present invention, the term “poly(ether sulfone) polymer [polymer (PESU)]” is intended to denote any polymer wherein more than 50% by moles of the recurring units of said polymer (PESU) are recurring units of formula:

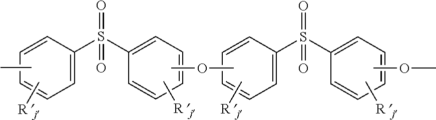

wherein each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium, and each of j′, equal to or different from each other and at each occurrence, is independently zero or is an integer from 0 to 4.

Non-limiting examples of polymers (PESU) suitable for the invention include, for instance, those described in WO 2014/072447 (SOLVAY SPECIALTY POLYMERS ITALY S.P.A.) May 15, 2014.

Non-limiting examples of polymers (PESU) suitable for the invention include those commercially available under the trademark name VERADEL® PESU from Solvay Specialty Polymers USA L.L.C.

For the purpose of the present invention, the term “poly(arylene) polymer [polymer (PA)]” is intended to denote any polymer comprising recurring units, wherein more than 50% by moles of the recurring units of said polymer (PA) are recurring units (R1) consisting of an arylene group, wherein said arylene group is a hydrocarbon divalent group consisting of one benzene ring or of a plurality of benzene rings fused together by sharing two or more neighbouring ring carbon atoms, said benzene ring being optionally substituted, wherein each of said arylene group is bound to two other arylene groups of neighbouring recurring units (R1) through a first C—C bond (E1) and a second C—C bond (E2), wherein at least 20% by moles of recurring units (R1) are kink-forming arylene units (R1-b) [arylene (R1-b) units hereinafter], the remainder being rigid rod-forming arylene units (R1-a) [arylene (R1-a) units hereinafter] different from arylene (R1-b) units, wherein in said arylene (R1-a) units the bond (E1) and the bond (E2) are co-linear and anti-parallel towards each other.

Preferred arylene (R1-a) units are p-phenylenes substituted by at least one monovalent substituting group.

More preferred arylene (R1-a) units are p-phenylenes substituted by at least one monovalent substituting group chosen from hydrocarbylketones [—C(═O)—R, where R is a hydrocarbyl group] and hydrocarbyloxyhydrocarbylketones [—C(═O)—R₁—O—R₂, where R₁ is a divalent hydrocarbon group and R₂ is a hydrocarbyl group], said hydrocarbylketones and hydrocarbyloxyhydrocarbylketones being themselves unsubstituted or substituted by at least one monovalent substituting group as those defined above.

Even more preferred arylene (R1-a) units are p-phenylenes substituted by at least one monovalent substituting group chosen from arylketones and aryloxyarylketones, said arylketones and aryloxyarylketones being unsubstituted or substituted by at least one monovalent substituting group as those defined above.

Most preferred arylene (R1-a) units are p-phenylenes substituted by an arylketone group, in particular by the phenylketone group.

Preferred arylene (R1-b) units are selected from the group consisting of recurring units (R1-b1) [arylene (R1-b1) units, hereinafter], recurring units (R1-b2) [arylene (R1-b2) units, hereinafter], recurring units (R1-b3) [arylene (R1-b3) units, hereinafter] and recurring units (R1-b4) [arylene (R1-b4) units, hereinafter].

Non-limiting examples of arylene groups contained in said arylene (R1-b1) units include 1,2-phenylene (or o-phenylene), 1,2-, 2,3- and 1,7-naphthylenes, 1,2-, 1,8-, 1,9-, 2,3-, 2,5- and 2,10-phenanthrylenes and 1,2- and 1,7-anthrylenes.

Non-limiting examples of arylene groups contained in said arylene (R1-b2) units include 1,3-phenylene (or m-phenylene), 1,3 - and 1,6-naphtylenes, 1,3-, 1,5-, 1,7-, 2,4-, 2,9- and 3,10-phenanthrylenes and 1,3- and 1,6-anthrylenes.

Non-limiting examples of arylene groups contained in said arylene (R1-b3) units include 1,8-naphthylene, 1,10- and 3,5-phenanthrylenes and 1,8- and 1,9-anthrylenes.

Non-limiting examples of polymers (PA) suitable for the invention include, for instance, those described in WO 2014/086744 (SOLVAY SPECIALTY POLYMERS ITALY S.P.A.) Jun. 12, 2014.

For the purpose of the present invention, the term “glow discharge process” is intended to denote a process powered by a radio-frequency amplifier wherein a glow discharge is generated by applying a voltage between two electrodes in a cell containing an etching gas medium. The glow discharge so generated is then typically transferred, commonly using a jet head, onto the surface of the material to be treated. Alternatively, the material to be treated is put between the electrodes in the cell containing the etching gas medium so that the glow discharge so generated is directly in contact with the surface of the material to be treated.

The glow discharge process typically comprises grafting one or more molecules onto at least a portion of the surface of the core provided in step (i) or step (i′) of the process of the invention.

For the purpose of the present invention, the term “grafting” is used according to its usual meaning to denote a radical process by which one or more functional groups are inserted onto the surface of a polymer backbone.

The term “functional group” is used herein according to its usual meaning to denote a group of atoms linked to each other by covalent bonds.

At least a portion of the surface of the core of the multilayer assembly of the invention advantageously comprises one or more grafted functional groups.

At least a portion of the surface of the core provided in step (ii) or step (ii′) of the process of the invention typically comprises one or more grafted functional groups advantageously obtainable by a glow discharge process.

For the purpose of the present invention, the expression “at least a portion”, when referred to the surface of the core comprising one or more grafted functional groups, is to be understood to mean that embodiments wherein the core has portions of its surface on which no grafted functional group is present are still encompassed by the present invention. Nevertheless, it is generally understood that substantially the entire surface of the core of the multilayer assembly of the invention comprises one or more grafted functional groups.

By “etching gas medium” it is hereby intended to denote either a gas or a mixture of gases suitable for use in a glow discharge process.

The glow discharge process is typically carried out in the presence of an etching gas medium comprising at least one gas selected from the group consisting of N₂, NH₃, CH₄, CO₂, He, O₂ and H₂.

The etching gas medium typically further comprises air.

The glow discharge process is preferably carried out in the presence of an etching gas medium comprising N₂ and/or NH₃, optionally, at least one gas selected from the group consisting of H₂ and He and, optionally, air.

According to an embodiment of the invention, the etching gas medium typically comprises N₂, preferably consists of:
from 5% to 95% by volume of N₂,
optionally, up to 15% by volume of H₂,
optionally, up to 95% by volume of He, and
optionally, up to 95% by volume of air.

The glow discharge process is typically carried out under reduced pressure or under atmospheric pressure.

The glow discharge process is preferably carried out under atmospheric pressure at about 760 Torr.

The glow discharge process may be carried out either under air or under modified atmosphere, e.g. under an inert gas, typically exempt notably from moisture (water vapour content of less than 0.001% v/v).

The glow discharge process is preferably carried out under air.

The glow discharge process is typically carried out at a radio-frequency comprised between 1 kHz and 100 kHz.

The glow discharge process is typically carried out at a voltage comprised between 1 kV and 50 kV.

The glow discharge process typically generates a plasma discharge.

The grafted functional groups typically comprise one or more atoms of the etching gas medium. The grafted functional groups are preferably selected from the group consisting of N-containing functional groups.

Non-limiting examples of grafted functional groups obtainable by a glow discharge process using an etching gas medium comprising, preferably consisting of, N₂ and/or NH₃, optionally, at least one gas selected from the group consisting of H₂ and He and, optionally, air, include, notably, N-containing functional groups such as amide groups (—CONH₂), amine groups (—NH₂), imine groups (—CH═NH) and nitrile groups (—CN).

The nature of the grafted functional groups of at least a portion of the surface of the core of the multilayer assembly of the invention can be determined according to any suitable techniques such as, for instance, FT-IR techniques, preferably Attenuated Total Reflectance (ATR) coupled to FT-IR techniques, or X-ray induced photoelectron spectroscopy (XPS) techniques.

The Applicant has found that, after treatment by a glow discharge process using an etching gas medium, the so treated surface of the core of the multilayer assembly of the invention successfully maintains its bulk properties including its mechanical properties.

The Applicant has also found that, after treatment by a glow discharge process using an etching gas medium, the metal shell is successfully adhered to the so treated surface of the core of the multilayer assembly of the invention.

For the purpose of the present invention, by “electroless plating” it is meant a process carried out in an electrochemical cell, typically in a plating bath comprising at least one metal salt, wherein the metal cation of the metal salt is reduced from its oxidation state to its elemental state in the presence of suitable chemical reducing agents.

Under step (iii-a) of the process of the invention, at least a portion of the core provided in step (ii) is coated by electroless deposition using a liquid composition [composition (L1)] comprising at least one metal salt [salt (M1)], said salt (M1) being typically a salt of a compound (M1).

Under step (iii-a′) of the process of the invention, at least a portion of the core provided in step (ii′) is coated by electroless deposition using a liquid composition [composition (L1)] comprising at least one metal salt [salt (M1)], said salt (M1) being typically a salt of a compound (M1).

For the purpose of the present invention, the expression “at least a portion”, when referred to the surface of the core coated with a metal shell, is to be understood to mean that embodiments wherein the core has portions of its surface on which no metal shell is adhered to are still encompassed by the present invention. Nevertheless, it is generally understood that substantially the entire surface of the core has adhered thereto a metal shell as defined above.

The compound (M1) typically comprises one or more metals selected from the group consisting of Cu, Ni, Pd, V, Fe, Cr, Mn, Co, Zn, Mo, W, Ag, Au, Pt, Ru, Pd, Sn, alloys thereof and derivatives thereof.

The composition (L1) typically comprises at least one salt (M1), at least one organic solvent [solvent (S)] and at least one reducing agent [agent (R)].

The solvent (S) is typically selected from the group consisting of:
aliphatic, cycloaliphatic or aromatic ether oxides, more particularly, diethyl oxide, dipropyl oxide, diisopropyl oxide, dibutyl oxide, methyltertiobutylether, dipentyl oxide, diisopentyl oxide, ethylene glycol dimethyl ether, ethylene glycol diethyl ether, ethylene glycol dibutyl ether benzyl oxide; dioxane, tetrahydrofuran (THF),
glycol ethers such as ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether,
glycol ether esters such as ethylene glycol methyl ether acetate, ethylene glycol monoethyl ether acetate, ethylene glycol monobutyl ether acetate,
alcohols such as methyl alcohol, ethyl alcohol, diacetone alcohol,
ketones such as acetone, methylethylketone, methylisobutyl ketone, diisobutylketone, cyclohexanone, isophorone, and
linear or cyclic esters such as: isopropyl acetate, n-butyl acetate, methyl acetoacetate, dimethyl phthalate, g-butyrolactone.

The agent (R) is typically selected from the group consisting of formaldehyde, hydrazine and sodium hypophosphite.

Under step (iii-a) of the process of the invention, at least a portion of the core provided in step (ii) is coated by electroless deposition by:
contacting at least a portion of the surface of the core provided in step (ii) with an electroless metallization catalyst thereby providing a catalytic surface; and
contacting the catalytic surface so obtained with a liquid composition [composition (L1)] comprising at least one metal salt [salt (M1)], said salt (M1) being typically a salt of a compound (M1).

Under step (iii-a′) of the process of the invention, at least a portion of the core provided in step (ii′) is coated by electroless deposition by:
contacting at least a portion of the surface of the core provided in step (ii′) with an electroless metallization catalyst thereby providing a catalytic surface; and
contacting the catalytic surface so obtained with a liquid composition [composition (L1)] comprising at least one metal salt [salt (M1)], said salt (M1) being typically a salt of a compound (M1).

The electroless metallization catalyst is typically selected from the group consisting of catalysts derived from palladium, platinum, rhodium, iridium, nickel, copper, silver and gold.

The electroless metallization catalyst is preferably selected from catalysts derived from palladium such as PdCl₂.

For the purpose of the present invention, by “electrodeposition” it is meant a process carried out in an electrolytic cell wherein electrons flow through an electrolytic composition comprising at least one metal salt from a positive electrode to a negative electrode thereby causing the inorganic anion of the metal salt to be oxidised at the positive electrode and the metal cation of the metal salt to be reduced at the negative electrode so that a layer consisting of a metal in its elemental state is deposited onto said negative electrode.

For the purpose of the present invention, the term “positive electrode” is intended to denote the anode where oxidation takes place. For the purpose of the present invention, the term “negative electrode” is intended to denote the cathode where reduction takes place.

Under step (iii-b) of the process of the invention, at least a portion of the layer (L1) provided in step (iii-a) is coated by electrodeposition using a liquid composition [composition (C2)] comprising at least one metal salt [salt (M2)], said salt (M2) being typically a salt of a compound (M2).

Under step (iii-b′) of the process of the invention, at least a portion of the layer (L1) provided in step (iii-a′) is coated by electrodeposition using a liquid composition [composition (C2)] comprising at least one metal salt [salt (M2)], said salt (M2) being typically a salt of a compound (M2).

For the purpose of the present invention, the expression “at least a portion”, when referred to the surface of the layer (L1), is to be understood to mean that embodiments wherein the layer (L1) has portions of its surface on which no layer (L2) is adhered to are still encompassed by the present invention. Nevertheless, it is generally understood that substantially the entire surface of the layer (L1) has adhered thereto a layer (L2) as defined above, if any.

The layer (L1) of the metal shell provided in step (iii-a) or step (iii-a′) of the process of the invention typically operates as a negative electrode.

The compound (M2) typically comprises one or more metals selected from the group consisting of Rh, Ir, Ru, Ti, Re, Os, Cd, TI, Pb, Bi, In, Sb, Al, Ti, Cu, Ni, Pd, V, Fe, Cr, Mn, Co, Zn, Mo, W, Ag, Au, Pt, Ir, Ru, Pd, Sn, Ge, Ga, alloys thereof and derivatives thereof.

The composition (L2) typically comprises at least one salt (M2) and at least one organic solvent [solvent (S)] as defined above.

The electrodeposition may be carried out either under inert atmosphere or under air atmosphere. The electrodeposition is advantageously carried out under air atmosphere.

The electrodeposition is typically carried out at a temperature of at most 120° C. The electrodeposition is typically carried out at a temperature of at least 20° C.

The metal shell of the multilayer assembly of the invention typically has a thickness comprised between 100 nm and 10 μm, preferably between 150 nm and 2 μm.

The thickness of the metal shell of the multilayer assembly of the invention can be measured according to any suitable techniques such as, for instance, scanning electron microscope (SEM) techniques or by using any suitable thickness gauges.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

Raw Materials

Foam (P-A): Closed-cell polymer foam consisting of a VDF-HFP polymer having a density comprised between 30 and 300 Kg/m³.

Manufacture of Foam (P-A)

The foam (P-A) was prepared following the general procedure described in Example 1 of US 2014/0171524 (JSP CORPORATION) Jun. 19, 2014 .

### EXAMPLE 1

### Manufacture of a Foam Assembly [Assembly (A1)]

### EXAMPLE 1-a

### Plasma Treatment

An atmospheric plasma treatment was performed on one surface of the sample of foam (P-A) by means of Plasmatreater AS400 in the following conditions:
nozzle-substrate distance: 12 mm,
gas flow: 2500 nl/h,
gas composition: 95% N₂+5% H₂,
source power: 870 VA,
nozzle scan speed: 60 m/min, 2 passes.

The sample so obtained will be hereinafter referred to as “plasma-treated foam (P-A)”.

### EXAMPLE 1-b

### Metallization

The sample of plasma-treated foam (P-A) obtained according to the procedure of Example 1-a was subjected to the following steps.

Step (a): the sample of plasma-treated foam (P-A) was cleaned by dipping in a suitable solution containing isopropyl alcohol and, then, contacted with a PdCl₂ solution. The palladium ions were reduced to metallic palladium. Then, electroless deposition of copper was performed at 45° C. by dipping the sample in a bath containing copper sulfate, a stabilizer agent and a pH corrector for 90 seconds thereby providing a sample of foam (P-A) coated with a metal layer (“layer (L1-a)”) having a thickness of 200 nm.

Step (b): the sample of foam (P-A) coated with the layer (L1-a) provided in step (a) was subjected to electrodeposition at room temperature by dipping the sample in an acidic solution containing copper salts for 20 minutes thereby providing a metal layer (“layer (L2-a)”) adhered to the layer (L1-a), said layer (L2-a) having a thickness of 2 μm. A 15 mA/cm² current was imposed by the generator ELEKTRO-AUTOMATIK EA-PSI 8080-40.

Measurement of Toxic Gas Components of Smokes

Emissions of HF were measured according to AITM 3.0004 standard method.

As shown in Table 1 here below, it has been found that the multilayer assembly according to the invention is advantageously endowed with outstanding flame spread resistance so that emissions of toxic gases during a fire are successfully drastically reduced as compared with the polymer foam as such.

TABLE 1

| | | HF |
|---|---|---|
| | Thickness | [ppm] |
| Foam (P-A) | 30 mm | 300 |
| Assembly (A1) | Foam (P-A): 30 mm | <5 |
| | Layer (L1-a): 200 nm | |
| | Layer (L2-a): 2 μm | |

1. A multilayer assembly comprising:
a core consisting of a composition (C) comprising at least one polymer foam (P) and,
adhered to said core, a metal shell at least partially coating said core, said metal shell comprising at least one layer (L1), said layer (L1) consisting of a composition (C1) comprising at least one metal compound (M1), and, optionally, at least one layer (L2), said layer (L2) consisting of a composition (C2) comprising at least one metal compound (M2).

2. The multilayer assembly according to claim 1, wherein foam (P) comprises at least one polymer foam bead (P).

3. The multilayer assembly according to claim 1, wherein the foam (P) has a density comprised between 5 and 300 Kg/m³.

4. The multilayer assembly according to claim 1, wherein at least one portion of the surface of the core comprises one or more grafted functional groups.

5. The multilayer assembly according to claim 4, wherein the grafted functional groups are selected from the group consisting of N-containing functional groups.

6. The multilayer assembly according to claim 1, wherein compound (M1) comprises one or more metals selected from the group consisting of Cu, Ni, Pd, V, Fe, Cr, Mn, Co, Zn, Mo, W, Ag, Au, Pt, Ru, Pd, Sn, alloys thereof and derivatives thereof.

7. The multilayer assembly according to claim 1, wherein compound (M2) comprises one or more metals selected from the group consisting of Rh, Ir, Ru, Ti, Re, Os, Cd, Tl, Pb, Bi, In, Sb, Al, Ti, Cu, Ni, Pd, V, Fe, Cr, Mn, Co, Zn, Mo, W, Ag, Au, Pt, Ir, Ru, Pd, Sn, Ge, Ga, alloys thereof and derivatives thereof.

8. The multilayer assembly according to claim 1, wherein the metal shell has a thickness comprised between 100 nm and 10 μm.

9. The multilayer assembly according to claim 1, wherein foam (P) comprises at least one fluoropolymer [polymer (F)].

10. The multilayer assembly according to claim 9, wherein polymer (F) is a polymer (F-1) comprising recurring units derived from vinylidene fluoride (VDF) and, optionally, at least one fluorinated monomer (F) different from VDF.

11. The multilayer assembly according to claim 1, said multilayer assembly further comprising an outer shell, said outer shell surrounding the metal shell.

12. A process for the manufacture of the multilayer assembly according to claim 1, said process comprising:
(i) providing a core consisting of a composition (C) comprising at least one polymer foam (P).
(ii) treating at least a portion of the surface of the core provided in step (i) by a radio-frequency glow discharge process using an etching gas medium,
(iii) providing a metal shell, said metal shell being obtainable by:
(iii-a) coating by electroless deposition at least a portion of the core provided in step (ii) using a liquid composition (L1) comprising at least one metal salt (M1) thereby providing at least one layer (L1), said layer (L1) consisting of a composition (C1) comprising at least one metal compound (M1), and
(iii-b) optionally, coating by electrodeposition at least a portion of the layer (L1) provided in step (iii-a) using a liquid composition (C2) comprising at least one metal salt (M2) thereby providing at least one layer (L2) consisting of a composition (C2) comprising at least one metal compound (M2), and
(iv) optionally, applying an outer shell onto the metal shell provided in either step (iii-a) or step (iii-b), if any.

13. A process for the manufacture of the multilayer assembly according to claim 2, said process comprising:
(i′) providing a core consisting of a composition (C′) comprising at least one polymer foam bead (P),
(ii′) treating at least a portion of the surface of the core provided in step (i′) by a radio-frequency glow discharge process using an etching gas medium,
(iii′) providing a metal shell, said metal shell being obtainable by:
(iii-a′) coating by electroless deposition at least a portion of the core provided in step (ii′) using a liquid composition (L1) comprising at least one metal salt (M1) thereby providing at least one layer (L1), said layer (L1) consisting of a composition (C1) comprising at least one metal compound (M2), and
(iii-b′) optionally, coating by electrodeposition at least a portion of the layer (L1) provided in step (iii-a′) using a liquid composition (C2) comprising at least one metal salt (M2) thereby providing at least one layer (L2) consisting of a composition (C2) comprising at least one metal compound (M2).
(iv′) moulding the foam beads (P) provided in either step (iii-a′) or step (iii-b′) thereby providing a multilayer assembly, and
(v′) optionally, applying an outer shell onto the multilayer assembly provided in step (iv′).

14. The process according to claim 12, wherein the etching gas medium comprises at least one gas selected from the group consisting of N₂, NH₃, CH₄, CO₂, He, O₂ and H₂.

15. An aerospace, rail, automotive, packaging or industrial item comprising the multilayer assembly according to claim 1.

16. The process according to claim 13, wherein the etching gas medium comprises at least one gas selected from the group consisting of N₂, NH₃, CH₄, CO₂, He, O₂ and H₂.

17. The multilayer assembly according to claim 2, wherein foam (P) consists of at least one polymer foam bead (P).

18. The multilayer assembly according to claim 3, wherein foam (P) has a density comprised between 20 and 200 Kg/m³.

19. The multilayer assembly according to claim 8, wherein the metal shell has a thickness comprised between 150 nm and 2 μm.

20. The multilayer assembly according to claim 9, wherein foam (P) consists of at least one polymer (F).
